(19) United States
(12) Patent Application Publication
(10) Pub. No.: US 2010/0081108 A1
(43) Pub. Date: Apr. 1, 2010

(54) THREE-WAY SYRINGE ADAPTER

(75) Inventor: Thomas J. Webster, West Jordan, UT (US)

Correspondence Address: Workman Nydegger;1000 Eagle Gate Tower, 60 East South Temple, Salt Lake City, UT, 84111, US

(73) Assignee: Ultradent Products, Inc., South Jordan, UT (US)

(21) Appl. No.: 12/565,417

(22) Filed: Sep. 23, 2009

Related U.S. Application Data
(60) Provisional application No. 61/101,371, filed on Sep. 30, 2008.

(51) Int. Cl. A61C 17/02

(52) U.S. Cl. 433/80

(57) ABSTRACT

An adapter for use with an air/water tip (e.g., a three-way dental syringe). The adapter comprises a body including a proximal end and a distal end, a mixing chamber disposed between the proximal and distal ends, a water delivery lumen for delivering water from a coupleable fluid dispensing device to the mixing chamber, and a separate air delivery lumen for delivering air from a coupleable fluid dispensing device to the mixing chamber. The cross-sectional area of the water delivery lumen at a location adjacent the mixing chamber is greater than the cross-sectional area of the air delivery lumen at a location adjacent the mixing chamber. The relative cross-sectional areas act to balance pressures of air and water entering the mixing chamber so as to provide a ratio of volumetric flow rate of water to air that is between about 0.5:1 to about 2:1.

### CROSS-REFERENCE TO RELATED APPLICATION

The present application claims the benefit of U.S. Patent Application Ser. No. 61/101,371, filed Sep. 30, 2008, entitled “THREE-WAY SYRINGE ADAPTER”, the disclosure of which is incorporated by reference in its entirety.

### BACKGROUND OF THE INVENTION

1. The Field of the Invention

The present invention generally relates to a coupling adapter for use with an air/water tip of a fluid dispensing apparatus known as a “three-way” syringe.

2. The Relevant Technology

FIG. 1 depicts a conventional three-way syringe 10 having a bent air/water tip 20 inserted into the dispensing head 12 of three-way syringe 10. The term “three-way” refers to the ability of the syringe to selectively deliver air, water, or both air and water. Air/water tip 20 enables the three-way syringe 10 to deliver these fluids. Such syringes are widely used by dentists, for example to deliver air, water, or both to a tooth during cleaning or a restoration process. It is often desirable to couple a delivery tip including a small diameter orifice to provide additional precision in delivery of the air, water, or mixture fluid. Adapters for facilitating coupling of delivery tips are the subject of U.S. Pat. Nos. 5,378,149 and 6,510,970, the disclosures of which are incorporated herein by specific reference.

One drawback of existing adapters and delivery tip systems is their tendency to inhibit fluid flow or at least require additional adjustment when attempting to deliver an air-water mixture through a very small orifice delivery tip. In other words, when attempting to deliver an air-water mix under such conditions, the result is that either only air is delivered, only water is delivered, or substantially no fluid flow occurs at all. When attempting to deliver a mixture of air and water, the practitioner must fine tune the water and air pressures on the instrument head 12. Each attempted adjustment may or may not be successful, typically requiring further adjustments and fine tuning. Such fine tuning and troubleshooting with the controls on head 12 can be annoying and time consuming from the perspective of the practitioner, particularly because the success rate of ad hoc adjustment is low.

### SUMMARY OF THE PREFERRED EMBODIMENTS

The present invention is directed to an adapter for use with an air/water tip (e.g., a three-way dental syringe). The adapter comprises a body including proximal and distal ends, a mixing chamber extending between the ends, one or more water delivery lumens extending through the proximal end for delivering water to the mixing chamber, and one or more air delivery lumens extending through the proximal end for delivering air to the mixing chamber. The total cross-sectional area of the water delivery lumens at their distal orifices (i.e., at a location adjacent the mixing chamber) is greater than the total cross-sectional area of the air delivery lumens at their distal orifices (i.e., at a location adjacent the mixing chamber). Providing one or more water lumens with greater cross-sectional area relative to the cross-sectional area of the air lumens automatically aids in balancing the fluid pressures at the lumen orifices into the mixing chamber, preventing inhibition of either fluid stream flow. In addition, balancing of fluid pressures provides a ratio of volumetric flow rate of water to air that is between about 0.5:1 and about 2:1. Ideally, the ratio of volumetric flow rate of water to air is about 1:1.

Water is of much greater density than air (about 800 times greater), while the viscosity of water is significantly greater than that of air (about 50 times greater). Because of this, all else being equal, the flow of water will be inhibited relative to the flow of air. Reducing the lumen cross-section through which the air flows acts to inhibit air flow relative to water flow, which helps to balance the pressures of air and water, and to bring the ratio of volumetric flow rate of water to air closer to 1:1. In a typical three-way syringe, pressurized air may be provided at about 0.5 to 0.6 MPa, while pressurized water may be provided at about 0.2 to about 0.4 MPa. The small diameter air lumen acts to reduce the air pressure so as to be more in line with the water pressure. Balancing the back pressures of the air and water streams at the orifices into the mixing chamber minimizes the tendency for one stream to shut down under back pressure from the other.

From a practical perspective, providing separate lumens for water and air flow, and sizing the lumens so as to provide a ratio of volumetric flow rate of water to air within this range, advantageously allows the practitioner to couple a small orifice delivery tip to the adapter, and still deliver a mix of air and water without having to make manual adjustments to the pressures of air or water, as is normally required in the absence of using the inventive adapter. In addition, by providing a water lumen orifice cross-sectional area that is greater than 1 to about 4 times greater than the air lumen orifice cross-sectional area, the inventors have surprisingly and unexpectedly observed a tendency of the water/air mixture to pulsate when exiting the delivery tip. This results in air/water mixture fluid flows of predominantly water followed spontaneously by predominantly air, which is then followed spontaneously again by an air/water mixture flow of predominantly water. Such pulsation continues indefinitely. This pulsation effect (more water/less air followed by more air/less water) aids in agitating and breaking up materials against which the fluid stream flow is directed. In other words, a pulsating air/water stream tends to apply dynamic and greater forces against the target materials compared to a continuous air/water stream of the same diameter and average pressure. The pulsation effect is believed to result from air bubbles within the mixing chamber being compressed as they move through the small diameter delivery tip and then collapsing just prior to exit.

In one embodiment, a single lumen is provided for water delivery, while a separate single lumen is provided for air delivery. The water delivery lumen is sized larger than the air delivery lumen in order to provide sufficient water flow relative to air flow. For example, the ratio of the diameter of the water delivery lumen adjacent the mixing chamber relative to the diameter of the air delivery lumen adjacent the mixing chamber is greater than 1:1 and less than about 2:1. Sizing the water delivery lumen to be larger than the air delivery lumen advantageously balances the fluid pressures and provides the ability to deliver a water/air mixture at a ratio of water volume flow to air volume flow that is more balanced (i.e., ideally about 1:1), which provides the ability to deliver the mixture without the need to adjust the air or water pressures on the fluid dispensing device. Furthermore, it surprisingly and unexpectedly provides the pulsation characteristic described above.

These and other benefits, advantages and features of the present invention will become more full apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is a perspective view of a conventional three-way dental syringe including an air/water tip inserted into the dispensing head;

FIG. 2A is an exploded view of the three-way syringe, an exemplary adapter positioned for insertion into the dispensing head, and a small orifice dispensing tip;

FIG. 2B is a perspective view of the adapter of FIG. 2A inserted into the dispensing head and the small orifice dispensing tip coupled to the adapter;

FIG. 3A is a cross-sectional view of the adapter of FIG. 2A;

FIG. 3B is a cross-sectional view of the small orifice dispensing tip of FIG. 2A;

FIG. 4A is a cross-sectional view of the adapter and small orifice dispensing tip of FIG. 2B coupled to the dispensing head;

FIG. 4B is another cross-sectional view of the adapter and small orifice dispensing tip of FIG. 2B coupled to the dispensing head;

FIG. 5A is a cross-sectional view of an alternative adapter including multiple air delivery lumens;

FIG. 5B is a proximal end view of the adapter of FIG. 5A;

FIG. 6A is a cross-sectional view of another alternative adapter;

FIG. 6B is a close up cross-sectional view of the air and water delivery lumens of the adapter of FIG. 6A; and

FIGS. 7A-7B illustrate how the adapter and coupled small orifice dispensing tip deliver a pulsating flow of an air/water mixture that is predominantly water (FIG. 7A) spontaneously followed by a pulsating flow of an air/water mixture that is predominantly air (FIG. 7B).

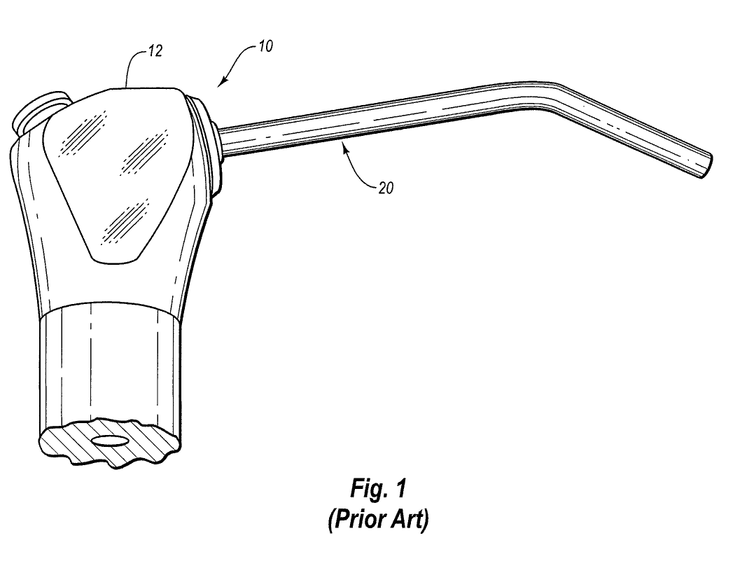

### DETAILED DESCRIPTION OF THE PREFERRED EMBODIMENTS

I. Introduction

The present invention is directed to an adapter for use with an air/water tip (e.g., a three-way dental syringe). The adapter comprises a body including a proximal end and a distal end with a mixing chamber disposed between the proximal and distal ends of the body, one or more water delivery lumens extending through the proximal end for delivering water from a coupleable fluid dispensing device to the mixing chamber, and one or more air delivery lumens extending through the proximal end for delivering air from a coupleable fluid dispensing device to the mixing chamber. The total cross-sectional area of the one or more water delivery lumens at their distal orifices (i.e., where the lumens enter the mixing chamber) is greater than the total cross-sectional area of the one or more air delivery lumens at their distal orifices (i.e., where the lumens enter the mixing chamber). The relative areas are configured so as to balance the air and water pressures entering into the mixing chamber, and to provide a ratio of volumetric flow rate of water to air that is between about 0.5:1 to about 2:1, more preferably about 0.75:1 to about 1.33:1, and most preferably between about 0.9:1 and about 1.1:1 (e.g., 1:1 being ideal).

Providing one or more water lumens that are relatively larger than the provided air lumen(s) aids in balancing the fluid pressures at the lumen orifices and within the mixing chamber, preventing inhibition of either fluid stream flow. For example, typically the water stream has a more difficult time passing through a small orifice because of its greater viscosity and density. Reducing the size of the air lumen(s) permits the water to flow more freely relative to the air, helping to equalize applied back pressures within the delivery lumens for air and water, while at the same time providing a more balanced volumetric ratio of fluid flow through the mixing chamber and out the dispensing tip.

As used herein, the term water is used to include water as well as aqueous solutions and mixtures. In its broadest sense, the term water may also refer to other non-aqueous liquids, for example if a device similar to a three-way dental syringe were being used to deliver a liquid other than water.

II. Exemplary Adapters and Fluid Dispensing Systems

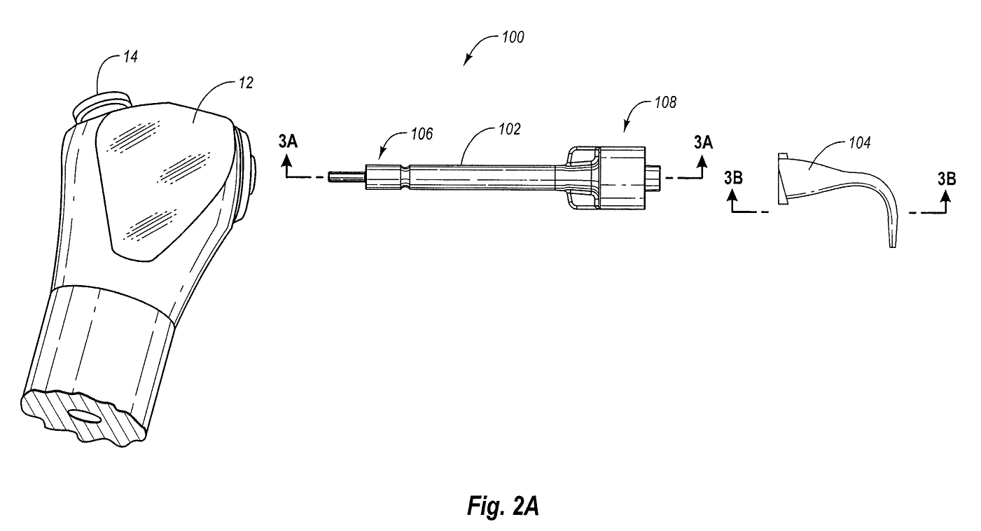

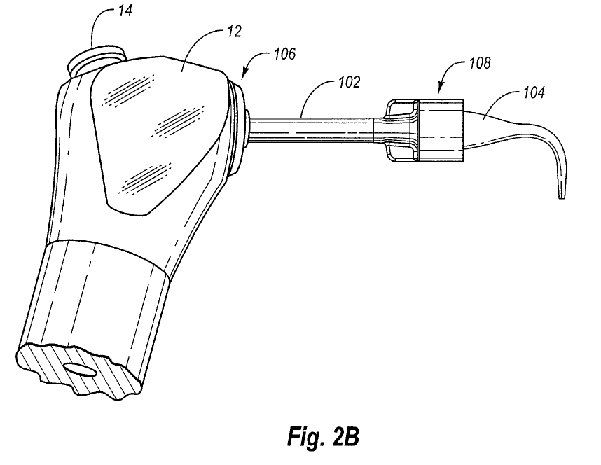

FIGS. 2A-2B illustrate an exemplary three-way dental syringe fluid dispensing system 100 including dispensing head 12 as well as the inventive adapter 102 and a dispensing tip 104 configured for coupling to the distal end of adapter 102. Dispensing head 12 includes two pressure control buttons 14. One button activates the flow of water, while the other activates the flow of air. When both buttons are depressed, a mixture of air and water is provided. When connecting a small diameter delivery orifice to a typical three-way dental syringe, the relatively small water volume flow actually plugs the delivery orifice, because of the higher density and viscosity of water relative to that of air, inhibiting flow of a balanced stream of an air/water mixture.

The inventive adapter serves to adjust the ratio of volumetric flow of water to air much closer to an ideal ratio of 1:1, which advantageously prevents the dispensing system from inhibiting or halting fluid flow when attempting to deliver an air/water mix through a small orifice delivery tip. Adapter 102 includes a proximal end 106 and a distal end 108. Proximal end 106 is configured to be received within and to couple with dispensing head 12. Distal end 108 is configured to couple with separate dispensing tip 104, through which the air, water, or air/water mixture is dispensed.

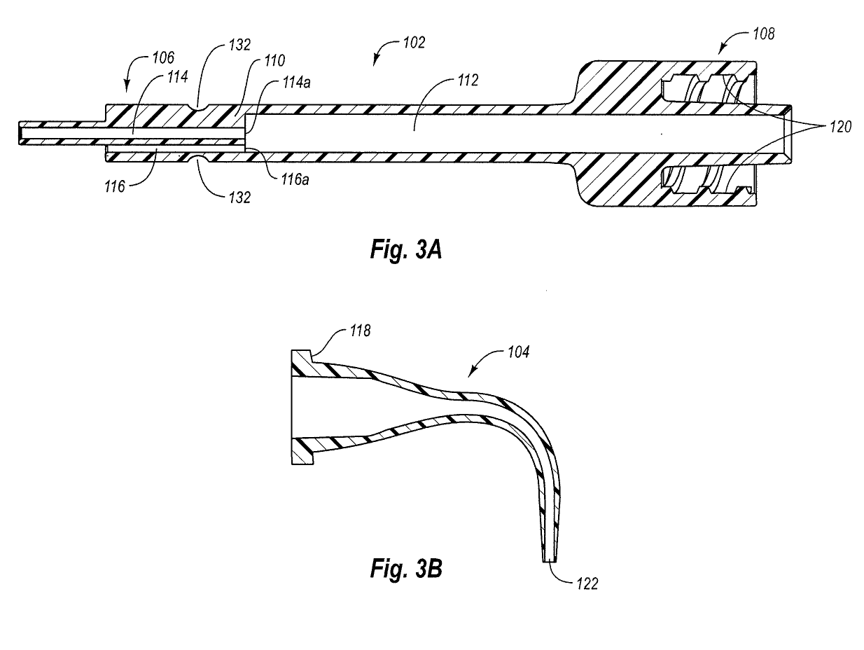

As shown in FIG. 3A, adapter 102 includes a body 110 defining an internal mixing chamber 112 extending between the distal end 108 and proximal end 106. Proximal end 106 of adapter 102 includes a water delivery lumen 114 and a separate air delivery lumen 116 that are in fluid communication with mixing chamber 112. When coupled to dispensing head 12, water from head 12 flows through water delivery lumen 114, and air from head 12 flows through separate air delivery lumen 116.

The cross-sectional area of air delivery lumen 116 at location 116a adjacent to mixing chamber 112 where lumen 116 enters mixing chamber 112 is advantageously smaller than the cross-sectional area of water delivery lumen 114 at location 114a adjacent to mixing chamber 112 where lumen 114 enters mixing chamber 112. The relative diameters of lumens 114 and 116 are advantageously sized so as to balance internal back pressure within the mixing chamber, and to provide a ratio of volumetric flow rate of water to air that is between about 0.5:1 and about 2:1 when delivering an air/water mixture. Ideally, the ratio of volumetric flow rate of water to air is maintained at about 1:1, although excellent results (i.e., the ability to deliver an air/water mixture through a coupled small orifice dispensing tip 104, particularly in a pulsing fashion) are still attainable at ratios of volumetric flow rate of water to air between about 0.5:1 and about 2:1, although better results are possible at ratios between about 0.75:1 and about 1.33:1. Optimum results are achieved at ratios between about 0.9:1 and about 1.1:1 (e.g., about 1:1).

The embodiment of FIG. 3A provides a ratio of volumetric flow rate of water to air that is about 1:1. For example, water lumen may have a diameter at location 114a of about 0.03 inch and air lumen may have a diameter at location 116a of about 0.02 inch. With typical provided air pressures between about 0.5 and about 0.6 MPa, and water pressures between about 0.2 and about 0.4 MPa, the inventors have found that such water/air lumen diameter ratios about 1.5:1) balances the fluid pressures within the mixing chamber 112, preventing an unbalanced back pressure in the lumens which would inhibit flow of either the air or water stream through their respective delivery lumens. Even though optimum results are achieved at a volumetric flow rate ratio of about 1:1, the inventors have found that acceptable results are possible at somewhat higher and somewhat lower ratios. For example, if the water lumen has a diameter at location 114a of about 0.04 inch and the air lumen has a diameter at location 116a of about 0.02 inch, the resulting ratio of water lumen diameter to air lumen diameter is about 2:1. Because the air lumen is even smaller relative to the water lumen in this example, the volumetric flow rate of water would be increased relative to the volumetric flow rate of air, resulting in a flow rate ratio of higher than the previous example, but still less than about 2:1. In embodiments including a single water delivery lumen and a single air delivery lumen as shown in FIG. 3A, the ratio of the diameter of the water delivery lumen 214 to the diameter of air delivery lumen 216 is greater than 1:1 and less than about 2:1, more preferably the ratio is between about 1.25:1 and about 1.75:1, and most preferably, the ratio is about 1.5:1.

As perhaps best seen in FIG. 3A, the mixing chamber 112 is significantly larger in diameter and longer than the water and air delivery lumens 114 and 116. Mixing chamber may have a diameter that is at least about 2 times larger than the diameter of water delivery lumen 114. Preferably, the diameter of mixing chamber 212 is at least about 3 times larger than the diameter of water delivery lumen 114. In addition, mixing chamber 112 occupies the majority of the length of body 110. For example, mixing chamber 112 advantageously includes a length that is longer than the length of water delivery lumen 114. Preferably, the length of mixing chamber 112 is at least about two times the length of the water delivery lumen 114.

The foregoing size relationships provide multiple benefits. For example, the length of mixing chamber 112 allows the air and water streams from lumens 116 and 114, respectively, to flow into mixing chamber 112. Because of the length of the chamber 112, good mixing of the streams is possible prior to compression of the mixture once it enters the reduced diameter lumen of the delivery tip 104.

In addition, according to one embodiment, the adapter is manufactured relatively inexpensively by injection molding a suitable plastic material (e.g., polypropylene and/or polyethylene). The adapter may advantageously be molded as a single integral piece, requiring no assembly. Such manufacturing methods allow the adapter to be sold at low cost, encouraging disposal after use. Promoting single use and disposability advantageously reduces the risk of cross-contamination if used with multiple patients. For example, existing adapters in use are typically formed of metal, which manufacture is complex and expensive. The result is that such adapters are not readily disposable, but must be disinfected when reused. It is impractical to dispose of an adapter costing hundreds of dollars after a single use.

When injection molding the inventive adapter, multiple core pins may be used. The core pins of the mold may occupy the mixing chamber on one end, and the water and air delivery lumens on the other end. The relative shortness of the water and air delivery lumens is a practical advantage from a manufacturing perspective as the core pins occupying these spaces (which spaces are very narrow—necessitating thin core pins) can be short, promoting their rigidity during manufacture of the adapters by molding. In one example, it may be desirable to use a core pin that is thicker at the proximal base end relative to the distal tip. Such is possible because it is the diameter and cross-sectional area at locations 116a and 114a that are more important to regulating the ratio of volumetric flow of water to that of air. As such, the core pin (e.g., particularly the smallest core pin that fits within air delivery lumen 116 during molding) may be thicker at its proximal end as compared to the distal end adjacent mixing chamber 112. Such thickening of a portion of the core pin may provide additional rigidity to the core pin, which is advantageous during manufacture of the adapters by injection molding. Such a tapered core pin results in a tapered lumen.

FIG. 3B illustrates a cross-sectional view of the coupleable small diameter orifice delivery tip 104. The illustrated tip includes coupling threads 118 configured to couple with coupling grooves 120 at the distal end 108 of adapter 102 (e.g., by means of a LUER-LOC connection). Other coupling mechanisms may alternatively be employed. Tip 104 advantageously allows the practitioner to more precisely deliver air, water, or an air/water mixture through small orifice 122. For example, orifice 122 may measure 14 gauge (inner diameter (“ID”)=0.062 in), 18 gauge (ID=0.038 inch), or even 19 gauge (ID=0.032 inch). In the absence of balancing the internal back pressures within water and air lumens 114, 116 (i.e., by sizing the water lumen orifice larger than the air lumen orifice), fluid flow through dispensing orifice 122 nearly or completely stops when such small tips are coupled to the dispensing head 12. This tendency to halt fluid flow is more pronounced with higher gauge tips having smaller inside orifice diameters. The inventive adapters extend the practitioner's ability to employ smaller orifice tips for greater precision while delivering an air-water mixture. In addition, the inventive adapter can, in at least some cases, provide a pulsating effect during fluid delivery not observed with other adapters and/or tips.

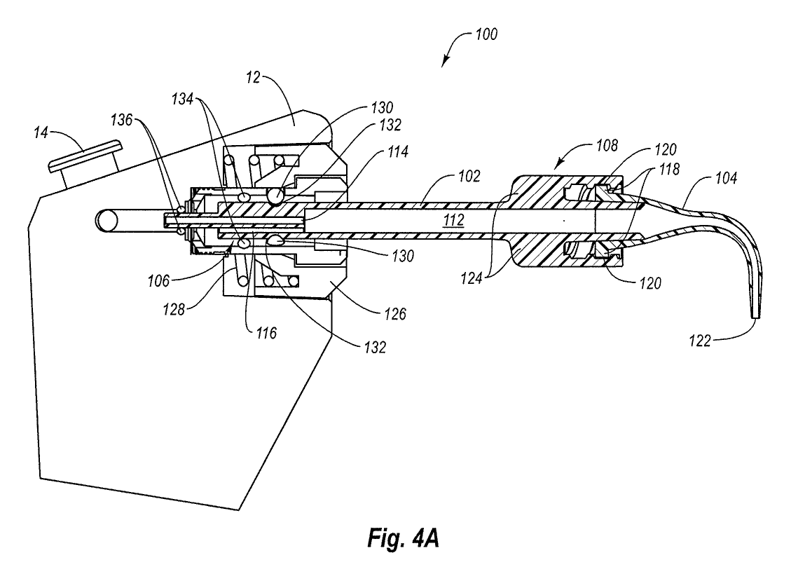

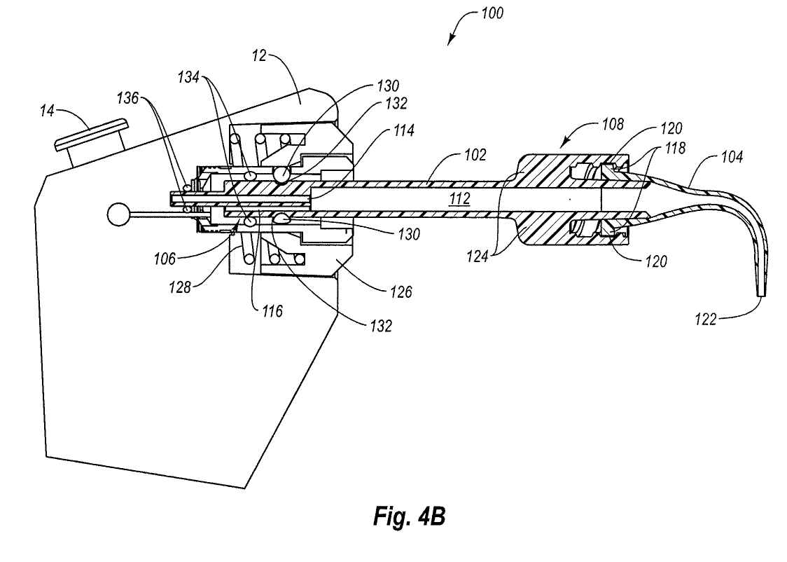

FIGS. 4A-4B illustrate adapter 102 coupled within dispensing head 12, with delivery tip 104 coupled to the distal end 108 of adapter 102. FIG. 4A shows a cross-section in which the channel for water delivery from head 12 to adapter 102 is shown. FIG. 4B illustrates a different cross-section in which the channel for air delivery from head 12 to adapter 102 is shown. Adapter 102 and/or tip 104 may advantageously include molded longitudinally extending torque wings 124 adjacent coupling distal end 108 and/or threads 118 to aid in coupling tip 104 to adapter 102 (e.g., by twisting). Dispensing head 12 may include any mechanism for coupling to adapter 102. One such common coupling mechanism is shown in FIGS. 4A-4B in which head 12 includes a collet 126 biased by springs 128. In order to insert or remove the adapter 102, the practitioner may push collet 126 proximally, allowing engagement ball 130 to slide out of the way of groove 132 of adapter 102. When collet 126 is released, engagement ball 130 is held in place by the collet, engaging within groove 132. O-rings 134 and 136 are disposed within the adapter head so as to seal against body 110, preventing leakage of air and/or water.

Water flow is selectively provided from dispensing head 12 into the open proximal end of water delivery lumen 114. Air flow is selectively provided from dispensing head 12 into the open proximal end of air delivery lumen 116. In the illustrated embodiment, water lumen 114 extends proximally further than air delivery lumen 116, such that water lumen 114 is longer than air lumen 116. Such a configuration is helpful in preventing water from entering into the proximal end of air lumen 116, and vice versa. Although the open proximal ends of lumens 114 and 116 are illustrated as opening at locations parallel to the longitudinal axis of adapter 102, alternative designs may provide the proximal opening at another location (e.g., so that the opening is perpendicular to the longitudinal axis). In either case, air and water enter the proximal portions of respective lumens 116 and 114. The smaller diameter of the air delivery lumen 116 advantageously provides a balancing of back pressures in the mixing chamber at orifices 116a and 114a. In addition, the balancing of back pressures provides a more balanced volumetric flow of water and air that is within the ranges described above. In the case of delivery of an air/water mixture, the air and water enter into mixing chamber 112 from lumens 116 and 114 respectively, where they mix together as the mixture moves distally towards coupled delivery tip 104 to be delivered as described above.

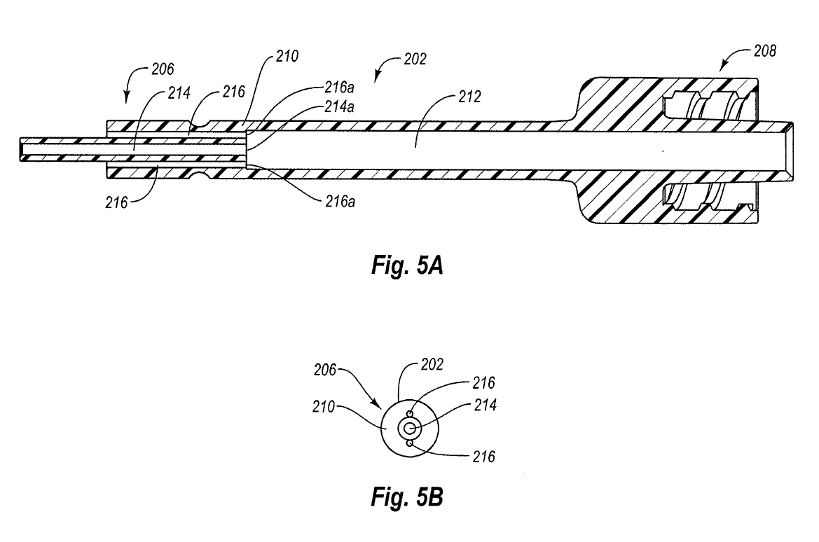

FIGS. 5A-5B illustrate an alternative exemplary adapter 202 including multiple (e.g., 2) air lumens 216 and a single water lumen 214. Of course, alternative embodiments may include multiple water lumens with a single air lumen or multiple air lumens. Similar to adapter 102, adapter 202 includes a body 210, a proximal end 206, a distal end 208, a mixing chamber 212 and a centrally disposed water delivery lumen 214. In the illustrated embodiment, air delivery lumens 216 are disposed on either side of water delivery lumen 214. In such an example, it is the total cross-sectional area of the air delivery lumens 216 at locations 216a, where each air delivery lumen enters mixing chamber 212, that is less than the cross-sectional area of water delivery lumen 214 at location 214a. In embodiments including multiple air delivery lumens, the total cross-sectional area of the air delivery lumens is less than the total cross-sectional area of the water delivery lumen. For example, in the illustrated embodiment, water delivery lumen 214 has a diameter at 214a of about 0.03 inch, while each air delivery lumen 216 has a diameter at 216a of about 0.014 inch. This results in the air delivery lumens 216 collectively having about the same total cross-sectional area as the single air lumen in the embodiment of FIG. 3A.

Such an embodiment performs similarly to that of FIG. 3A in that it provides a balancing of back flow pressures within mixing chamber 112, while also providing a ratio of water volume flow to air volume flow that is approximately 1:1, which allows an air/water mix to flow through a coupled tip as described above. In such embodiments, the total cross-sectional area of the water delivery lumen(s) at location 214a adjacent mixing chamber 212 is greater than the total cross-sectional area of the air delivery lumens 216 at location 216a adjacent mixing chamber 212. For example, the ratio of total cross-sectional area of the water delivery lumen(s) relative to the total cross-sectional area of air delivery lumens adjacent mixing chamber 212 is greater than 1:1 and less than about 4:1, more preferably between about 1.5:1 and about 3:1, and most preferably about 2.25:1.

Such an example may be less preferred relative to that of FIG. 3A, from a manufacturing perspective, as formation of the additional air lumen requires an additional core pin for injection molding, and the core pins are thinner (e.g., 0.014 inch) as compared to the smallest core pin (e.g., 0.020 inch) used in making the embodiment of FIG. 3A. Furthermore, the wall thickness between lumens and the exterior of body 210 may be less, making the adapter perhaps less strong, although the strength may be sufficient given the disposability of the adapter.

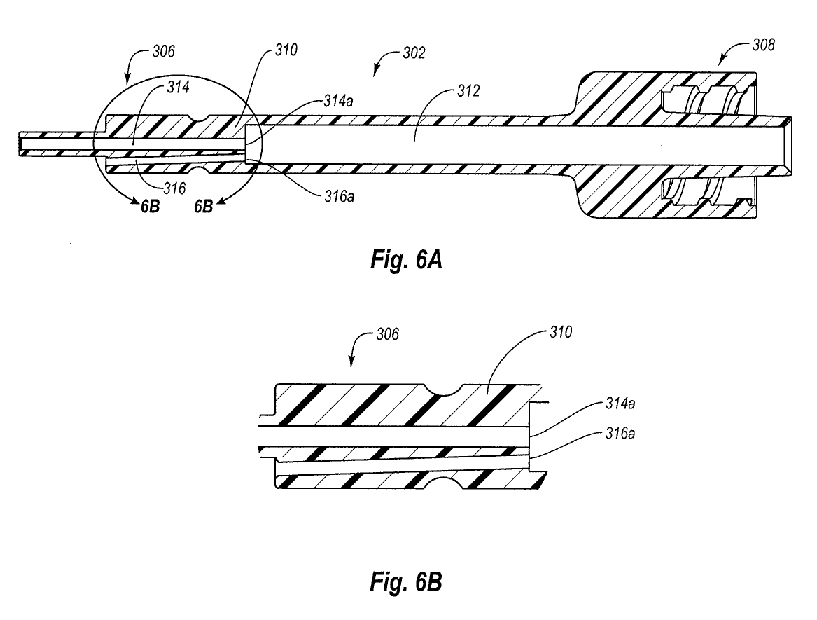

FIGS. 6A-6B illustrate another alternative exemplary adapter 302 including an air delivery lumen 316 that is non-parallel relative to water delivery lumen 314. Adapter 302 is similar to adapter 102 in that it includes a body 310, a proximal end 306, a distal end 308, a mixing chamber 312, a water delivery lumen 314, and an air delivery lumen 316. Rather than being substantially parallel to water delivery lumen 314, air delivery lumen 316 is slightly angled (e.g., preferably between about 1 degree and about 5 degrees, more preferably between about 2 degrees and about 3 degrees) towards the discharge end of water delivery lumen 314. The effect of such angling is to provide more turbulent swirling as air from air delivery lumen 316 enters into mixing chamber 312 at location 316a, impinging upon the stream of water entering into mixing chamber 312 at location 314a. Such a configuration advantageously provides for improved mixing of the air and water streams within mixing chamber 312.

In embodiments where the back flow pressures of air and water within mixing chamber 112 at locations 114a and 116a are balanced, the ability to deliver an air/water mix through the orifice 122 of tip 104 is optimized. In other words, a ratio of volumetric flow rate of water to air of about 1:1 is achieved by providing a ratio of total cross-sectional area of the water delivery lumen(s) to the total cross-sectional area of the water delivery lumen(s) that is about 2.25:1. Such difference in sizing accounts for differences in the densities and viscosities of the air and water streams, as well as the differences in typically provided water pressure relative to typically provided air pressure within standard three-way dental syringes.

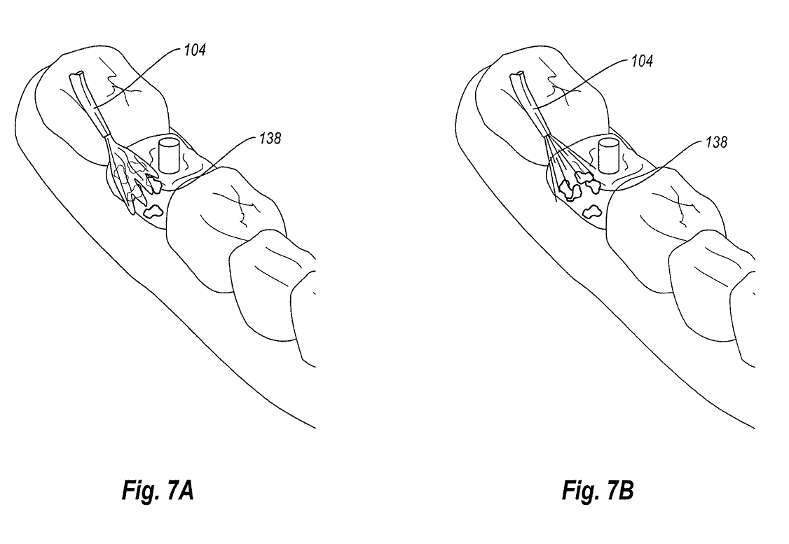

As shown in FIGS. 7A-7B, one advantageous and unexpected characteristic of employing the inventive adapter with small diameter delivery tip 104 is an observed pulsation effect. As shown in FIG. 7A, with the small delivery tip 104 coupled to system 100 (FIGS. 2B and 4A-4B), delivery of an air/water mix of predominantly water (FIG. 7A) is spontaneously followed by an air/water mix of predominantly air (FIG. 7B). Such delivery of a more dense mixture (FIG. 7A) followed by a less dense mixture (FIG. 7B) provides an agitating or abrading effect to debris 138 to be removed (e.g., during a dental restoration) as the more dense mixture pushes the debris and the less dense mixture allows it to spring back as less force is applied. Delivery of the more dense mixture then spontaneously follows the less dense mixture, and so on. Such spontaneous pulsing is helpful in breaking up and removing the debris during such a procedure as a result of the dynamic force application.

Although perhaps not fully understood, it is believed that the pulsation effect at least partially results from a balancing of the back pressures so as to provide balanced volumetric flow of air and water to mixing chamber 112, in addition to the compression and eventual cavitation that the air/water mixture undergoes as it progresses towards the small diameter orifice of delivery tip 104. Bubbles initially present within mixing chamber 112 begin to compress as they move into narrower delivery tip 104. Continuing compression of the mixture as a result of the narrowing tip 104 results in formation of cavitation microbubbles, which rapidly collapse under pressure from the surrounding fluid and narrowing delivery tip 104. As the cavitation bubbles collapse, a shock wave is released, which is believed to be at least partially responsible for the observed dynamic pulsation effect. For example, the shock wave may result in movement of the air and water components within the mixture, resulting in portions of predominantly air and predominantly water being grouped together.

It will be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. An adapter for coupling with an air/water tip of a fluid dispensing device such as a three way dental syringe, the adapter comprising:
a body including a proximal end and a distal end;
a hollow mixing chamber between the proximal and distal ends of the body;
one or more water delivery lumens extending through the proximal end of the body so as to provide fluid communication between a fluid dispensing device and the mixing chamber, the one or more water delivery lumens collectively having a total cross-sectional area at a location adjacent the mixing chamber; and
one or more air delivery lumens extending through the proximal end of the body so as to provide fluid communication between a fluid dispensing device and the mixing chamber, the one or more air delivery lumens having a total cross-sectional area adjacent the mixing chamber that is less than the total cross-sectional area of the one or more water delivery lumens, the cross-sectional areas of the lumens acting to balance pressures of air and water entering the mixing chamber so as to provide a ratio of volumetric flow rate of water to air that is between about 0.5:1 and about 2:1.

2. An adapter as recited in claim 1, wherein the ratio of volumetric flow rate of water to air is between about 0.75:1 and about 1.33:1.

3. An adapter as recited in claim 1, wherein the ratio of volumetric flow rate of water to air is between about 0.9:1 and about 1.1:1.

4. An adapter as recited in claim 1, wherein the ratio of volumetric flow rate of water to air is about 1:1.

5. An adapter as recited in claim 1, wherein the ratio of the total cross-sectional area of the one or more water delivery lumens relative to the total cross-sectional area of the one or more air delivery lumens at a location adjacent the mixing chamber is greater than 1:1 and less than about 4:1.

6. An adapter as recited in claim 1, wherein the ratio of the total cross-sectional area of the one or more water delivery lumens relative to the total cross-sectional area of the one or more air delivery lumens at a location adjacent the mixing chamber is between about 1.5:1 and about 3:1.

7. An adapter as recited in claim 1, wherein the ratio of the total cross-sectional area of the one or more water delivery lumens relative to the total cross-sectional area of the one or more air delivery lumens at a location adjacent the mixing chamber is about 2.25:1.

8. An adapter as recited in claim 1, wherein the mixing chamber has a length that is greater than the length of the one or more water delivery lumens.

9. An adapter as recited in claim 1, wherein the mixing chamber has a length that is at least about 2 times longer than the length of the one or more water delivery lumens.

10. An adapter as recited in claim 1, further comprising coupling means disposed at the distal delivery end of the adapter, further comprising a pair of torque wings disposed adjacent the coupling means.

11. An adapter for coupling with an air/water tip of a fluid dispensing device such as a three way dental syringe, the adapter comprising:
a body including a proximal end and a distal end;
a hollow mixing chamber between the proximal and distal ends of the body;
a single water delivery lumen extending through the proximal end of the body so as to provide fluid communication between a fluid dispensing device and the mixing chamber, the water delivery lumen having a diameter adjacent the mixing chamber; and
a single air delivery lumen extending through the proximal end of the body so as to provide fluid communication between a fluid dispensing device and the mixing chamber, the air delivery lumen having a diameter adjacent the mixing chamber that is less than the diameter of the water delivery lumen adjacent the mixing chamber, the cross-sectional areas of the lumens acting to balance pressures of air and water entering the mixing chamber so as to provide a ratio of volumetric flow rate of water to air that is between about 0.5:1 and about 2:1.

12. An adapter as recited in claim 11, wherein the ratio of the diameter of the water delivery lumen relative to the diameter of the air delivery lumen at a location adjacent the mixing chamber is greater than 1:1 and less than about 2:1.

13. An adapter as recited in claim 11, wherein the ratio of the diameter of the water delivery lumen relative to the diameter of the air delivery lumen at a location adjacent the mixing chamber is between about 1.25:1 and about 1.75:1.

14. An adapter as recited in claim 11, wherein the ratio of the diameter of the water delivery lumen relative to the diameter of the air delivery lumen at a location adjacent the mixing chamber is about 1.5:1.

15. An adapter as recited in claim 11, wherein the mixing chamber has a diameter that is at least about 2 times greater than the diameter of the water delivery lumen.

16. An adapter as recited in claim 11, wherein the mixing chamber has a diameter that is at least about 3 times greater than the diameter of the water delivery lumen.

17. An adapter as recited in claim 11, wherein the air delivery lumen and the water delivery lumen are substantially parallel to one another.

18. An adapter as recited in claim 11, wherein the air delivery lumen is non-parallel relative to the water delivery lumen so as to cause flow from the air delivery lumen turbulently impinge upon flow from the water delivery lumen upon entering the mixing chamber.

19. An adapter as recited in claim 11, wherein the water delivery lumen further comprises an extension that extends proximally beyond the air delivery lumen such that the water delivery lumen has a length greater than a length of the air delivery lumen.

20. An adapter for coupling with an air/water tip of a fluid dispensing device such as a three way dental syringe, the adapter comprising:
a body including a proximal end and a distal end;
a hollow mixing chamber between the proximal and distal ends of the body;
one or more water delivery lumens extending through the proximal end of the body so as to provide fluid communication between a fluid dispensing device and the mixing chamber, the mixing chamber having a length that is at least about 2 times greater than the length of the one or more water delivery lumens and a diameter that is at least about 2 times greater than the diameter of the water delivery lumen; and
one or more air delivery lumens extending through the proximal end of the body so as to provide fluid communication between a fluid dispensing device and the mixing chamber, wherein the ratio of the total cross-sectional area of the water delivery lumens at a location adjacent the mixing chamber relative to the total cross-sectional area of the one or more air delivery lumens at a location adjacent the mixing chamber is between about 1.5:1 and about 3:1 so as to more closely balance pressures of air and water entering the mixing chamber.

21. An adapter as recited in claim 20, wherein the ratio of the total cross-sectional area of the water delivery lumens at a location adjacent the mixing chamber relative to the total cross-sectional area of the one or more air delivery lumens at a location adjacent the mixing chamber is about 2.25:1.
